(19) United States
(12) Patent Application Publication
(10) Pub. No.: US 2001/0054066 A1
(43) Pub. Date: Dec. 20, 2001

(54) Apparatus and method for transmitting information from signage to portable computing device, and system utilizing same

(76) Inventor: Louis Spitzer, Brooklyn, NY (US)

Correspondence Address: FITZPATRICK CELLA HARPER & SCINTO, 30 ROCKEFELLER PLAZA, NEW YORK, NY, 10112, US

(21) Appl. No.: 09/728,599

(22) Filed: Dec. 1, 2000

Related U.S. Application Data
(63) Continuation-in-part of application No. 09/593,612, filed on Jun. 13, 2000.

(51) Int. Cl. G06F 15/16

(52) U.S. Cl. 709/203; 709/229

(57) ABSTRACT

A method, apparatus, and computer program for delivering data to a computing device by transmitting, from a local server, data to the computing device, where the data is associated with a display located in the vicinity of transmission.

### REFERENCE TO PARENT APPLICATION

This application is a continuation-in-part of Application Ser. No. 09/593,612 filed Jun. 13, 2000.

### BACKGROUND OF THE INVENTION

1. Field of the Invention

The present invention relates generally to the provision of information to remote devices such as hand held computers and other portable data processing apparatus by means of transmission of an electronic signal.

2. Related Art

There are many sources of information available in the streets, thoroughfares and public places of the modern world. Being out and about in no way restricts the availability of information to the mobile individual. Billboards provide a continual stream of text and graphic information to the pedestrian and motorist, cellular telephones provide connectivity as portals to the telephone networks, and wireless connections to the Internet facilitate access to the information superhighway through the portable computer.

However, the information available from these sources all has the same defect: ephemerality. Unlike the virtual world, where one can save a web page to a local hard drive with a few clicks, in the tangible world we walk through and live in man must record the information that he wants to save. If a billboard has useful information to a viewer, there remains the problem of recording it manually in the short time one has in the immediate vicinity of the billboard. The same problem inheres in information delivered by the broadcast media, such as radio or television, to the mobile listener or viewer.

On the other hand, if information is readily recordable, such as is the case with information available to the mobile individual from the virtual world, via the wireless Internet connections of portable computers, (which are now available even on hand held computing devices such as the Palm VII), it is the accessing of information that requires the human's time; the user must actively find within the virtual domain the information needed at the mobile location.

Existing portable hand held computing devices, also referred to as personal digital assistants (PDAs), such as the Palm III and later generations are capable of transmitting and receiving infrared and radio frequency signals. Some mobile phones, particularly those that are wireless application protocol (WAP) enabled, can include some of the same functions as PDAS. With the advent of these devices, there is a convenient marriage of truly hand held data processing devices with the means to directly access information from the tangible world that can be stored in, or that can point to a location in, the virtual world. In other words, it is now possible to take the human out of the information recording loop, and send real world information directly to the hand held device in nearly real time. This is easily accomplished by placing infrared or other electromagnetic transmitters in the streets and other public places, their signals capable of reception by anyone with a handheld computing device. The problem is that there is no readily available content; there is simply a dearth of real world information “out there” delivered via infrared (or any other wireless) electromagnetic signals.

If someone needs information about an item, store, event, or bus schedule in their immediate mobile environment, or if more information about a company, or its products, that one sees depicted on a nearby billboard is desired, all that can currently be done is to connect, via the handheld device, assuming it is so equipped, to the Internet and search for a website with the desired information. Alternatively, if a billboard caught one's attention as they passed by, and it recited a particular website URL, one would either have to go to the website then and there and access the information, or enter the URL for that website into the hand held device as an electronic note for future reference and connection. If there was simply no time to do either, the information would be lost.

Commuters spend large amounts of time waiting for trains to arrive or depart, buses to come to a particular stop, etc. They have free time at those moments for a diversion. Even if they have their PDA on and ready for a wireless connection, they may not want to connect to the Internet, their work intranet, or other similar systems. They would be interested in downloading entertainment, in the form of games, or other diversions, and multitudes of people in this situation present a captive audience at station after station, bus kiosk at bus kiosk, day after day. Such an audience can be used as the target of advertising, or as a market for entertainment. Yet, again, there is currently no entertainment, or other, content available in such an environment to access.

U.S. Pat. No. 5,835,861 (Whiteside) relates to a method for accessing a vendor's telephone number from an “active advertisement source” directly to a cellular telephone, through an infrared transmission of the data to the cellular telephone, which can then dial the number. While Whiteside describes a system where a very small, seven byte message, i.e., a telephone number, is transmitted to a requesting cellular telephone, its system does not describe the capability to provide content in any meaningful sense to hand held personal computing devices, such as have proliferated since Whiteside was filed.

Another mobile phone advertisement method has been proposed by Spotcast, Inc. Spotcast, Inc. proposes software that allows advertisers to target their intended audience on mobile phones by offering subscribers (who have previously filled in forms to reveal age, income, and interests) a chance to listen to a 10-second audio advertisement in exchange for one minute of free calling time. There is also the opportunity for the user to opt for further information on the advertisement, or get in touch with the advertiser itself. Some users may find it intrusive and annoying to have to listen an advertisement before making a short call, or even make them angry if an urgent connection is needed, such as in the case of an emergency. In addition, some might not want to give their time and attention every time they make a call.

Another company, called GeePS, Inc., is exploring the concept of location-based wireless coupons for mobile phone users, based on the Global Positioning System (GPS). The GeePS technology, working in conjunction with wireless service providers and using consumer profiles kept by Internet retailers, can send alerts to cell phone users about discount offers at nearby stores. The most obvious downside of this proposal is that, unless the mobile phone or the GPS element is shut down, the user's privacy is compromised. In addition, users of the GeePS proposal will be sitting targets for random unsolicited advertising campaigns. Accordingly, there is a need for a method to target consumers when they are receptive to advertisements.

Vindigo.com has proposed a personal navigation tool that allows a user to select a location from a list of preprogrammed street names or areas, and with that location it finds places to eat, shop, and play that are within a predefined distance to the selected location. It also includes reviews of restaurants, bars, movies. From an advertising point of view, the Vindigo.com proposal is missing some very effective marketing tools. For instance, it does not provide a means for impulse shoppers who see an advertisement in the real world the ability to immediately effectuate a purchase or find out what else the advertiser has to offer. With the Vindigo.com proposal, the user must first know what they want, make multiple inputs into a PDA, and then search through a list that contains a vendor they wish to deal with. The Vidigo.com system also fails to provide a guarantee that a particular vendor they wish to purchase from is on a list. Accordingly, there is a need for a system that provides a potential buyer the ability to view a vendor's advertisement on a sign, billboard or kiosk, or the like, and have instant access to that vendor as well as up to date information about what that particular vendor has to offer. The content should also made available without requiring a PDA or WAB user to connect to the Internet. Instead, satisfaction should be at the point of retrieval.

What is also missing in these systems is the control of the “smart” billboard by a local server or processor, itself connected to both a central system database as well as to third party content provider partners' databases and a publicly accessible computer communications network, such as the Internet. Another issue with portable PDAs is the amount of time it takes to exchange information. The latent nature of today's wireless devices and central servers are the cause of communication bottlenecks during complex queries. Seemingly instantaneous desktop requests can translate to many seconds of delivery time needed for a wireless device, and even more time is needed when a back-end server is being heavily tasked.

What is thus desired is the capability to deliver continually changing content, in the form of text, graphics, and executable files (i.e., pre-compiled), all of which can be accessed via the now ubiquitous hand held computing devices, via a system of “smart” signs, centrally tracked and updated by a central system. An integrated system providing such a capability would be able to fill the information void for the mobile computing device user on a scale hitherto unknown.

What is further needed is total interconnectivity of the hand held computing device, the system provider, and the totality of third party content providers, to facilitate the accessibility and transfer of information to all of the components of the system, i.e., the content provider databases and servers, the central system control, and the various transmitting devices located in the field, so as to provide up to the minute accurate information to the user.

What is further needed is a back-end system that is capable of processing considerable amounts of data, adding convenience for merchants and users, efficiently distributing content across multiple devices, and easily adjusting to a constantly changing technical environment.

### SUMMARY OF THE INVENTION

It is thus an object of the present invention to provide an apparatus, system, method, and program where the deficiencies of the prior art can be corrected, and information from a system of “smart” signs, kiosks and the like can be transmitted directly to a variety of handheld computing devices for the mutual benefit of the user, the information providers, as well as the other interested parties with a view towards commercializing such a service.

One embodiment of this invention is directed to a method, apparatus, and program for communicating data between a local server and a central server connected to a network by storing data onto the central server. This embodiment includes storing data onto the central server, storing an identification string onto the central server, loading the identification string onto a personal digital assistant device, loading the data onto the personal digital assistant device, transmitting the data from the personal digital assistant device to the local server, transmitting other data from the local server onto the personal digital assistant device, and transferring the other data from the personal digital assistant device to the central server.

A second embodiment of the present invention is a method, apparatus and program for connecting a browser to a web application server. This embodiment includes transmitting data to the personal digital assistant device, receiving and storing the data in the personal digital assistant device, synchronizing the personal digital assistant device with a personal computer, registering a user by providing user identification information to the web application server, launching a browser on the personal computer, posting information from the personal computer to the web application server, wherein the information includes: the data transmitted to the personal digital assistant, a timestamp, and a user identifier. This embodiment further includes storing the posted information onto a central server, and displaying on the browser information corresponding to the data.

A third embodiment of the invention is a method, apparatus and program for accessing Internet websites using a personal digital assistant and a personal computer connected to an Internet. This embodiment includes transmitting data from a local server to the personal digital assistant, where the data includes instructions on how to access a web application server, the instructions being viewable on the personal digital assistant, and location specific data. This embodiment further includes accessing the web application server, registering a user's information on the web application server, receiving a user identifier on the personal digital assistant after successfully completing the registering step, downloading and installing a conduit onto a personal computer after completing the registering step if the conduit is not already installed on the personal computer, triggering the conduit during a synchronization of the personal digital assistant to the personal computer, checking for the user identifier on the personal digital assistant device, sending the user identifier to the web application server from the personal digital assistant device if the user identifier is found, requesting the user's information from a central server via the Internet if the user identifier was not found in the checking step, locating other data on the central server associated with the location specific data, querying the central server for at least one hyperlink associated with the other data, and displaying the at least one hyperlink on a browser on the personal computer.

A fourth embodiment of the present invention is a method, apparatus and program for delivering data to a computing device with a browser. This embodiment includes viewing an identification number on a display, inputting the identification number into the computing device, connecting the computing device to a web application server via the Internet, transmitting from the computing device to the web application server the identification number, and receiving at the computing device from the web application server data associated with the display.

A fifth embodiment of the present invention is a method apparatus and program for delivering data to a wireless application protocol enabled device. This embodiment includes viewing an identification number on a display, inputting the identification number into the wireless application protocol enabled device, connecting the wireless application protocol enabled device to a web application server via the Internet, transmitting from the wireless application protocol enabled device to the web application server the identification number, receiving at the wireless application protocol enabled device from the web application server data associated with the display, extracting a subscriber identification of the wireless application protocol enabled device from a wireless application protocol gateway, mapping the data to a modified data, and alerting the user of the modified data.

### BRIEF DESCRIPTION OF THE DRAWINGS

The present invention will be more readily understood from a detailed description of the preferred embodiments taken in conjunction with the following figures.

FIG. 1 is an illustration of a user downloading information from a kiosk equipped with a transmitter of the present invention.

FIG. 2 is an illustration of the flow of data from the system database to the local kiosk through the remote transmission to the user.

FIG. 3 depicts an overview of the elements of an embodiment of the present invention.

FIG. 4 depicts the components of and flow of data in a first embodiment of the present invention.

FIG. 5 depicts the components of and flow of data in a second embodiment of the present invention.

FIG. 6 is an exemplary screen shot of the resident application being synchronized.

FIG. 7 depicts an exemplary screen shot from the user computer informing the user as to the conduit settings, and allowing the user to change them.

FIG. 8 depicts an exemplary screen shot from the user computer of the conduit settings screen for a Palm device showing the conduit.

FIG. 9 depicts an exemplary screen shot of the user prompt.

FIG. 10 is an exemplary screen display shot of the resident application icon on a hand held personal computing device main menu.

FIG. 11 is an exemplary screen display shot of the resident application home screen running on a hand held personal computing device.

FIG. 12 is an exemplary screen shot of the system web page.

FIG. 13 is an exemplary screen shot of the Coupons tab of the resident application.

FIG. 14 is an exemplary screen shot of the Info tab of the resident application.

FIG. 15 is an exemplary screen shot of the Games tab of the resident application.

FIG. 16 is a flow diagram showing the steps for processing WAP transactions.

FIG. 17 is a block diagram of the input and output data structures in accordance with processing a WAP transaction.

FIG. 18 is a process diagram showing the steps for maintaining advertisements on a kiosk local server.

FIG. 19 is a process diagram showing the steps for synchronizing a PDA using a conduit.

FIG. 20 is a process diagram showing the steps for downloading and installing a conduit in accordance with the present invention.

FIG. 21 is a block diagram of the conduit download process.

FIG. 22 is a block diagram of the conduit download process.

### DETAILED DESCRIPTION OF THE PREFERRED EMBODIMENTS

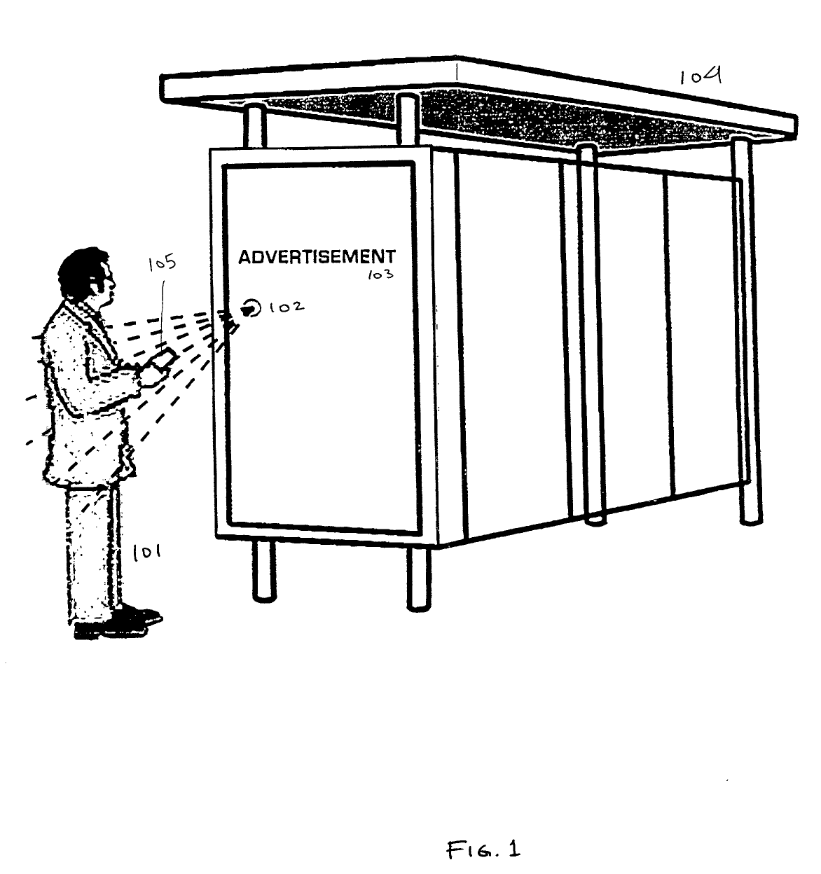

The apparatus, system and method of the present invention will be described in what follows with reference to the drawings. FIG. 1 depicts a typical installation of the device of the present invention according to the first or second embodiments of the invention, where the means of transmission between the sign and the remote hand-held computing device is an infrared (IR) beam, and the handheld computing device is a Palm personal digital assistant (PDA). A user, 101, holds a hand-held computing device within range of the transmitter, 102, after viewing an advertisement, 103, advising that the advertisement is “smart”, i.e., that it has information available to transmit to a hand-held computing device. In general, the invention contemplates a uniquely recognizable symbol, or logo, appearing on the advertisement 103 on each “smart” sign or kiosk, alerting the public to the fact that it is equipped with the device 102 of the invention, and thus there is information available for transmission. The particular installation depicted in FIG. 1 is at a bus stop shelter kiosk, 104. The actual device 102 sits in the kiosk, 104, behind an advertisement, 103. The advertisement 103 has a small hole in it where the infrared transceiver 102 transmits through. There is a graphic visible on the face of the advertisement 103, where the transceiver 102 is, that alerts people to the fact that there is a device 102 there, and that they may thus receive transmitted information to their hand-held computing device 105 from the advertisement 103.

The infrared transceiver is connected to a local server that resides in the kiosk housing, and is powered through an electrical connection provided at the kiosk. The local server's physical size, is, preferably, between that of a laptop computer and that of a package of gum. The server can be any one of a number of different types: such as, for example, (i) a motherboard from a laptop that is running a linux operating system, such as a Pentium motherboard running the Linux operating system, (ii) a java based server like the one depicted and described at http://www.ibutton.com which is a mini computer running a firmwear java based chip, or (iii) even a Palm VII handheld computing device. The local server communicates with the infrared transceiver through a serial port and a serial cable.

Those skilled in the art will realize that this invention also can be installed in other structures that hold advertisements, and still be within the scope of the invention. For example, this invention can be installed into a billboard, a phone booth, a telephone pole, a window display of a store, even a display within a store, and the like.

To speak to the network, the server is preferably provided with a cellular modem card. This card is connected directly to the server and to a cellular network, or the like, such as the Bell South cellular network, which is the same network that the Palm VII uses.

The components of the network should include connections to other complementary networks such as satellite networks, and host connections to the Internet. These components give the device the ability to be connected to the Internet and the database at all times. The network should also allow message traffic to be handled so as to be sent along the shortest path available. An example of such a suitable network is the BellSouth network. The BellSouth utilization is motivated by the strength of the BellSouth Intelligent Wireless Network^{SM}. The BellSouth network has core Mobitexâ technology, as well as connections to other complementary networks such as satellite networks, and host connections to the Internet. BellSouth Wireless Data operates its wireless data service throughout the United States, covering 93 percent of the urban U.S. business population located in more than 266 metropolitan areas, having a total population of 200 million people.

Once on the Bell South network a connection to the Internet is provided, as well as to the database server that contains the requisite information for each of the devices. The Mobitexa wireless data network is based on a distributed architecture which allows message traffic to be handled at the lowest possible level in the system, or the shortest path available. The advantages of utilizing this network are (i) greater reliability, in that messages are not lost, as well as (ii) increased speed, as messages move faster.

Mobitexâ networks are based on packet-switched technology, and are the wireless evolution of established landline packet-switched networks. In the packet-switched environment, messages, or information, are sent over the network in short bursts of data known as “packets”. Each packet holds up to 512 bytes of data, generally equal to three-quarters of a page of text. Larger transmissions are transparently broken into packets of 512 bytes and seamlessly reassembled at the receiving end.

Bell South manages the wireless communications between the terminal equipment used in each of the advertisement kiosks through their Mobitexa wireless data network. This network supports several different communication protocols including Mobitexa Asynchronous Command (MASC), Hayes AT (industry standard), CCIT X.28 (for X.25 connectivity). As an example, the device can connect to the network through the Hayes AT standard.

Alternatively, any communications network offering the functional advantages of the BellSouth network, as described above, could be used, such as wireless networks, fiber optic networks, or the like.

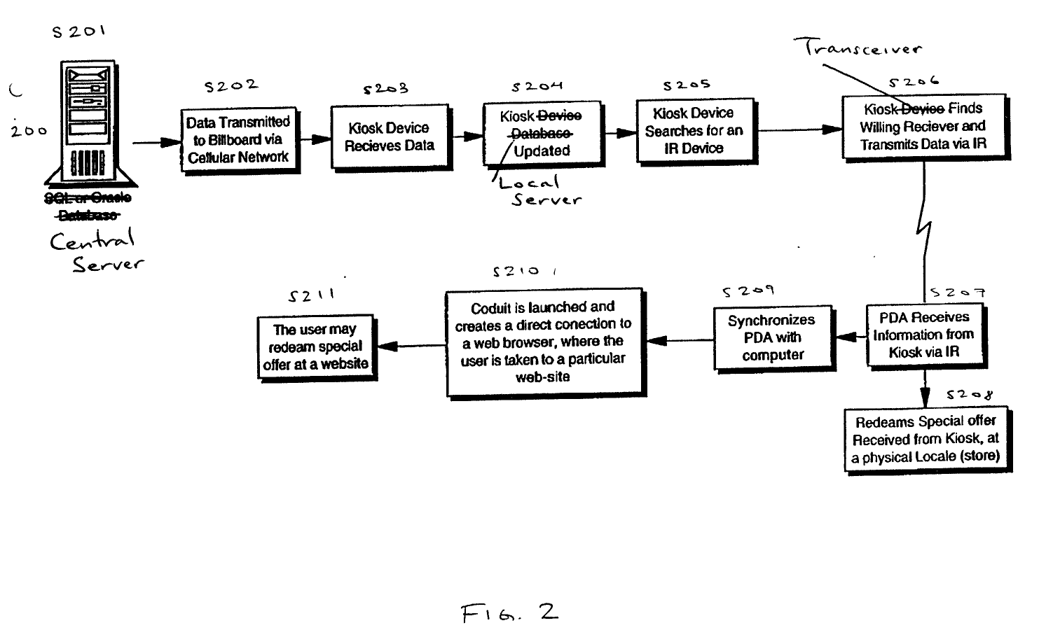

FIG. 2 depicts the flow of data through the system. Beginning with step S201, the central server, 200, has data to be transmitted from the remote IR transmitter 102 located on the advertisement 103, as depicted in FIG. 1. The central server can store data via a database program such as SQL or Oracle, or the like. In step S202 the data is transmitted to the billboard via a cellular network, such as, for example, the Bell South Network. At step S203 the transceiver, located at the kiosk where the advertisement is, receives the data, and thus at step S204 the local server is updated with the new data so that the transceiver is ready to transmit. The local server can store data by using a database program, or the like. In step S205 the transceiver searches for an IR enabled hand held computing device, such as, for example, a PDA, seeking transmission by continuously emitting a beacon signal, and at step S206 the transceiver finds a willing device, from which it receives a request for data, and transmits to it.

In step S207 the hand held device receives the data from the transceiver on the kiosk via the infrared signal, and at this point the data flow bifurcates, as according to the two embodiments of the invention.

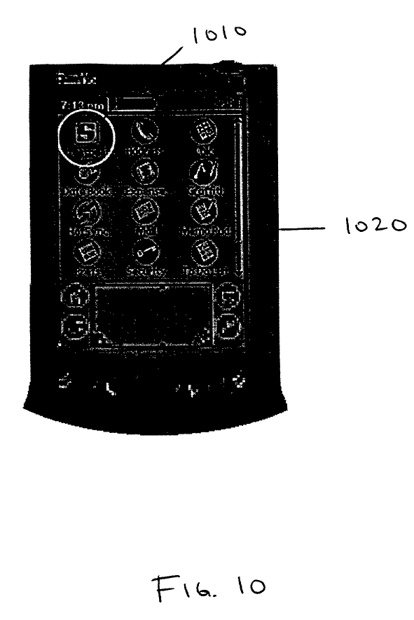

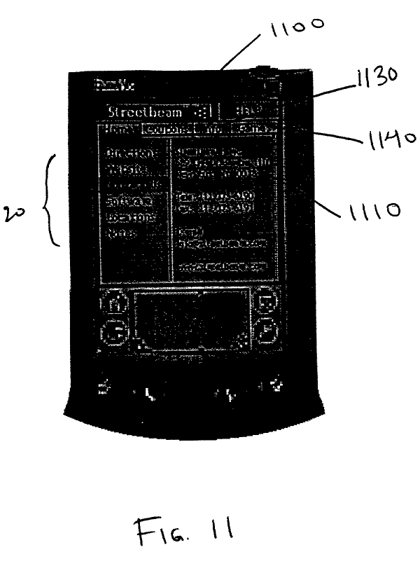

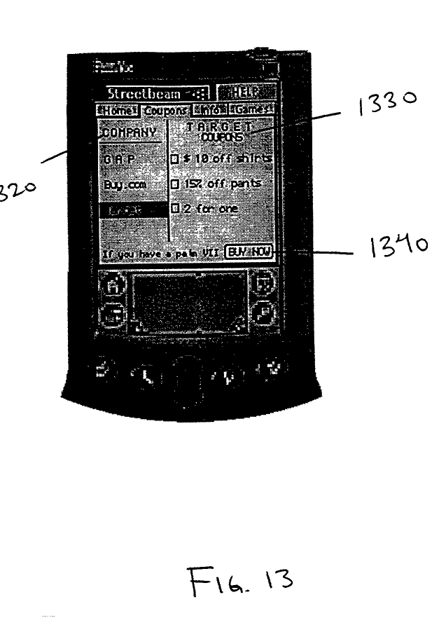

In the transmission depicted in step S207, a resident application is also passed to the user, and this application resides on the user's hand held computing device. In addition, a database file will be created on the user's device and will contain the information that was being advertised or offered for transmission. The resident application will display that information, and can also perform additional functions. FIG. 10 is an exemplary screen shot of a Palm PDA device 1020 showing the system icon 1010, indicating that the application has been downloaded onto the hand held device 1020, in this case the Palm device. As an example, in this screen shot the application and the system are identified by the brand name “Streetbeam” and a logo containing the word Streetbeam and a stylized “S” as shown by the icon 1010. FIG. 11 is an exemplary screen shot of the application running on the hand held device. The brand name 1100 appears in the top left of the displayed screen to identify the program, and a series of tabs appears in a line underneath. One of the tabs is the Coupons tab 1110, which the user clicks on to obtain the downloaded coupon and associated information. Another is the Info tab 1130, and the final tab available is the Games tab 1130. The home page of the application operates as follows. The menu items 1120 at the far left of the home page are clicked on and information appears on the right. In the example screen shot of FIG. 11 the “Contact Us” menu item 1120 has been selected, and the physical, telephone, email and World Wide Web contact information is displayed on the right side of the screen. Example screen shots which display upon the user's clicking the Coupons 1110, Info 1130 and Games 1140 tabs, respectively will now be described, with reference to FIGS. 13-15.

FIG. 13 is an example screen shot of the Coupons tab of the resident application. It is accessed by clicking on the Coupons tab 1110 on the resident application home screen as shown in FIG. 11. In this screenshot of FIG. 13 three stores are shown as having coupons which the user downloaded, i.e., GAP, Buy.com, and Target. The stores whose coupons have been downloaded are listed under the COMPANY menu heading 1320. In this example Target has been selected, and under the TARGET COUPONS heading 1330 at the top right of the screen the available TARGET coupons are displayed. In order to access these coupons, as described more fully below, the user either goes directly to the store, or goes to the coupon issuer's web page. Whether the coupon is redeemable at the store, on the web, or via both means is described upon clicking on the particular coupon on the right side of the screen. In the event the user has a Palm VII or other hand held computing device equipped with a wireless modem or other wireless data interface, then the user can click on the BUY NOW tab 1340 at the resident application home screen and go directly to the coupon issuer's web page and purchase the goods or services.

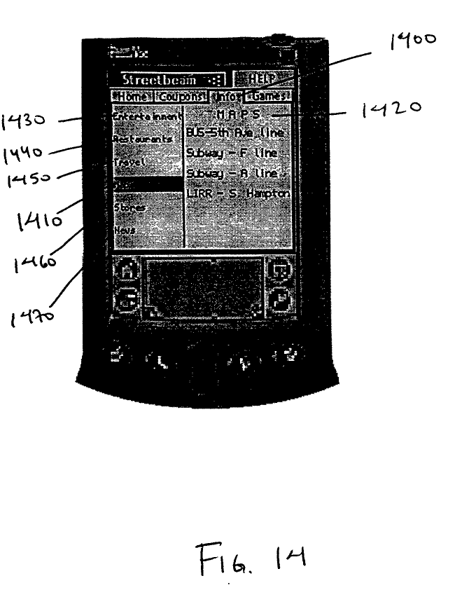

FIG. 14 is an example screen shot of the Info tab 1420 of the resident application. It is accessed by clicking on the Info tab 1130 at the resident application home screen, as depicted in FIG. 11. It contains different information downloaded by the user. In the screen shot shown in FIG. 14, the same format as is common to the entire resident application is again used, i.e., menu items to choose from on the left the screen, and information relating thereto displayed on the right side of the screen. In the Info tab 1400 screen display there are a variety of reference categories to choose from, such as Entertainment 1430, Restaurants 1440, Travel 1450, Maps 1410, Stores 1460 and News 1470. In this example screen shot the Maps 1410 menu category has been selected. On the right of the screen are therefore displayed various airport, subway, bus and commuter railroad maps, under the heading “MAPS” 1420 at the top right of the screen. In addition, airport, subway, bus, ferry, and commuter railroad schedules for transportation pickup locations can be downloaded and displayed onto the PDA. A user will know if they have time to shop at a nearby retailer while waiting for their transportation. Thus, a retailer whose location is near the transportation pickup location will find it advantageous to advertise with the present invention.

In addition, since the local server can be continuously updated with new information via leased line, wireless, or the like, transportation schedules can be continuously updated. This provides users with a convenient way of viewing accurate transportation schedule information.

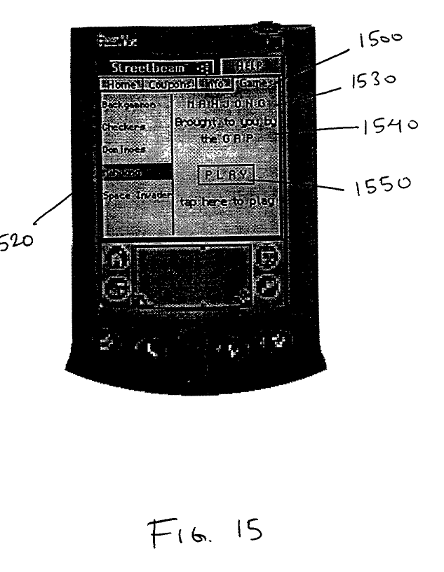

FIG. 15 is an example screen shot of the Games tab 1500. This screen displays the different games that the user has downloaded from available system signs, and, as above, follows the common format of the resident application. The names of the downloaded games are displayed in the left side of the screen menu, and the particular game 1530 selected appears at the top of the left side of the screen. There also appears the name of the sponsor 1540, in this case the GAP. There is a PLAY button 1550, which, if clicked, will launch the game. The Games tab 1500 relates to a third embodiment of the invention, as described below, where no coupon is issued or downloaded, but a sponsored game is offered to the user.

For example, a treasure hunt application can be downloaded to the PDA. This game can prompt a user to locate different kiosks and at each one collect pieces of the puzzle (i.e., in the form of data uploaded to the PDA). When the user has collected all the pieces to the puzzle, an award in the form of a coupon, gift certificate, or the like, can be downloaded to the PDA.

Returning to the process flow, again with reference to FIG. 2, step S208 depicts the first embodiment of the present invention, where the user physically goes to a retailer whose coupon or promotional premium has been transmitted from the transceiver onto the user's hand held computing device, such as a PDA (as shown in FIG. 2). In this option, after downloading the information from the sign, the user then goes to a store or other commercial establishment to redeem the received coupon or promotion, and the event is completed. Instructions for the redemption are found by clicking the coupons tab 1110 of FIG. 11. In this first embodiment, in order to actually redeem the coupon the coupon issuer's store or place of business has hardware and/or software capable of downloading the coupon from the user's hand held computing device, for example via an infrared transmission. The coupon can either be on a piece of paper printed out by the hardware, or it could be solely electronic, and transmitted, or if using infrared as in FIG. 2, beamed, directly into the store's database, to credit the user with a discount directly at the register at the point of sale.

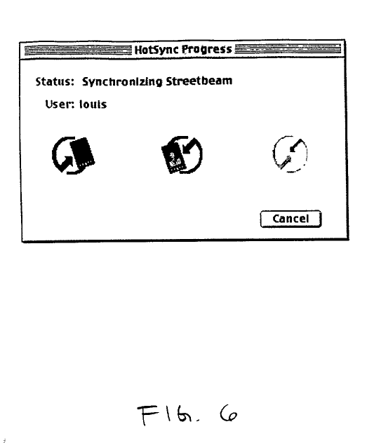

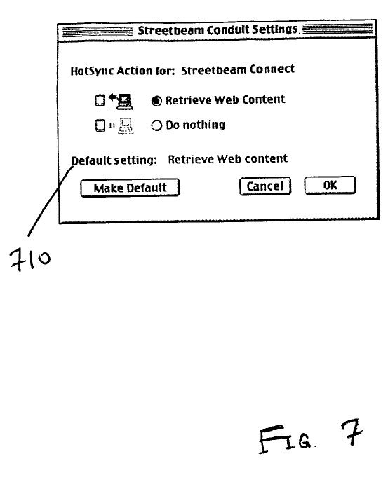

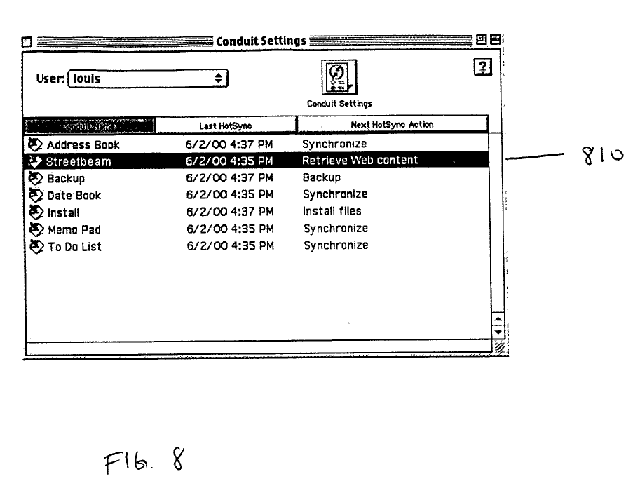

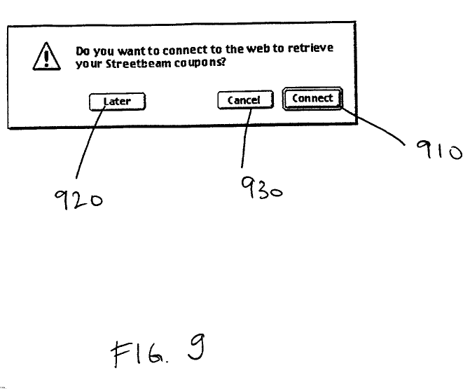

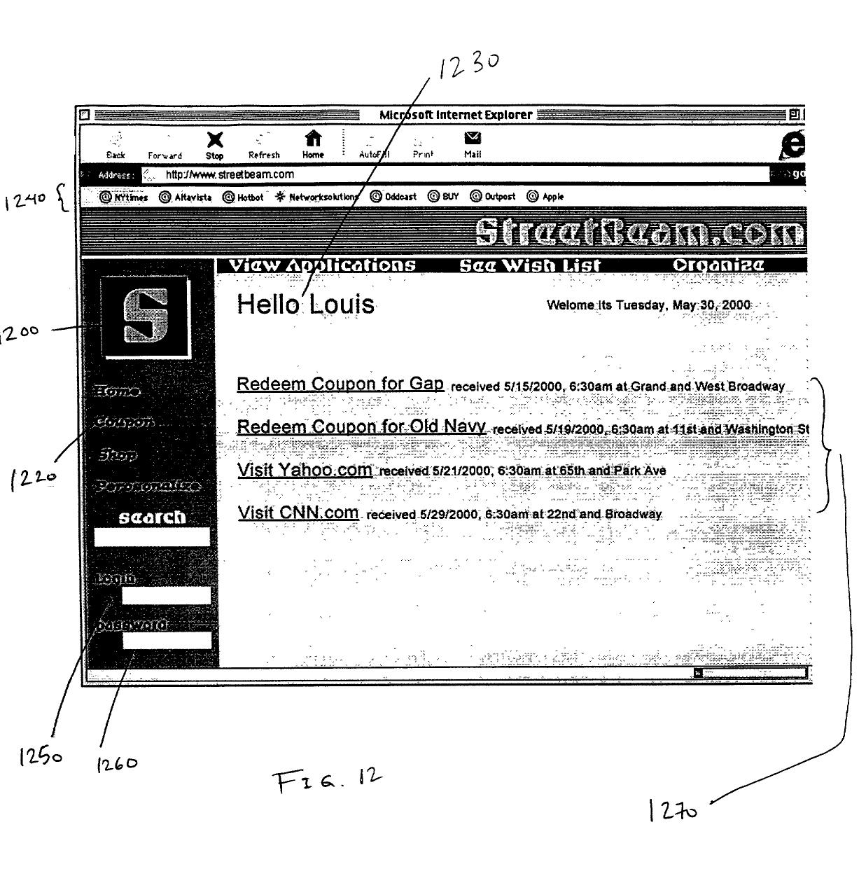

Steps S209-S211 depict the process flow for the second embodiment, where the user does not go to a physical venue to redeem the received coupon or promotion, but rather goes to the Internet, specifically to the advertiser's specified URL. In this scenario the user first synchronizes his hand held device. FIG. 6 is an exemplary screen shot of the resident application being synchronized. After synchronization, the resident application, which was downloaded with other data from the transceiver on the sign, executes, informing the user to go to a specified system URL so as to download the necessary conduit to allow full browser functionality. FIG. 7 is an exemplary screen shot, seen on the user computer, written for example, for a Palm PDA, informing the user about the conduit settings, and allowing the user to change them. FIG. 8 shows an example screen shot, seen on the user computer, indicating the various conduits and their actions at synchronization such as a HotSync for a Palm PDA device, or the like. The system conduit 810, labeled by the system brand name “streetbeam” appears on the list and indicates that it will retrieve web content at HotSync. Referring again to FIG. 7, the default setting for the conduit 710 is to retrieve Web content at synchronization. Once the conduit from the system site has been downloaded and installed on the user's computer, it will not need to be downloaded again. However, in order to download the software in the first instance, the user will need to create an account on the system web page, where they must leave pertinent information. The conduit download and installation process are described in more detail below. Referring again to FIG. 2, once the software is installed, at step S210, the conduit launches, and the user is prompted as to whether the user desires to retrieve coupons from the web. FIG. 9 is a screen shot of the prompt as seen by the user on his or her computer screen after synchronization. There are three tabs for interaction with this dialog box. The Connect tab 910, which will immediately connect the user to the coupon issuer's site, the Later tab 920, which will cause the user to be prompted at the next synchronization, and the Cancel tab 930, which allows the user to bypass the web connection. If the user chooses Cancel 930 then there will be no further prompts, as shown in FIG. 9, for that coupon, however the canceled coupon will still appear on the system home page, as depicted in FIG. 12, and the coupon issuer's website can be accessed via the link from the system home page. If the user chooses Connect 930, a browser is launched, and the user taken to the appropriate web site. Alternatively, the user is taken to the system home page, as depicted in FIG. 12, and from there can click on a link and be taken to the coupon issuer's site. In step S211, the user can redeem his or her coupon, completing the event.

FIG. 12 is an exemplary screen shot of the system web page. The system logo 1200 appears in the top left of the display screen, and the user logs in at the Login type-in-box 1250 and furnishes his or her password in the password type-in-box 1260. The system web page has useful links 1240, such as web search engines, news sources, and other content providers. The user sees a personalized message 1230, and sees a listing of the que 1270, in chronological order, of the as yet unexecuted system downloads from the signage. The user clicks on a que element 1270, and is taken to the merchant or information/service provider's web page for further action. As described above, in order to obtain the conduit to the coupon sponsor sites, the user must first register at the system site.

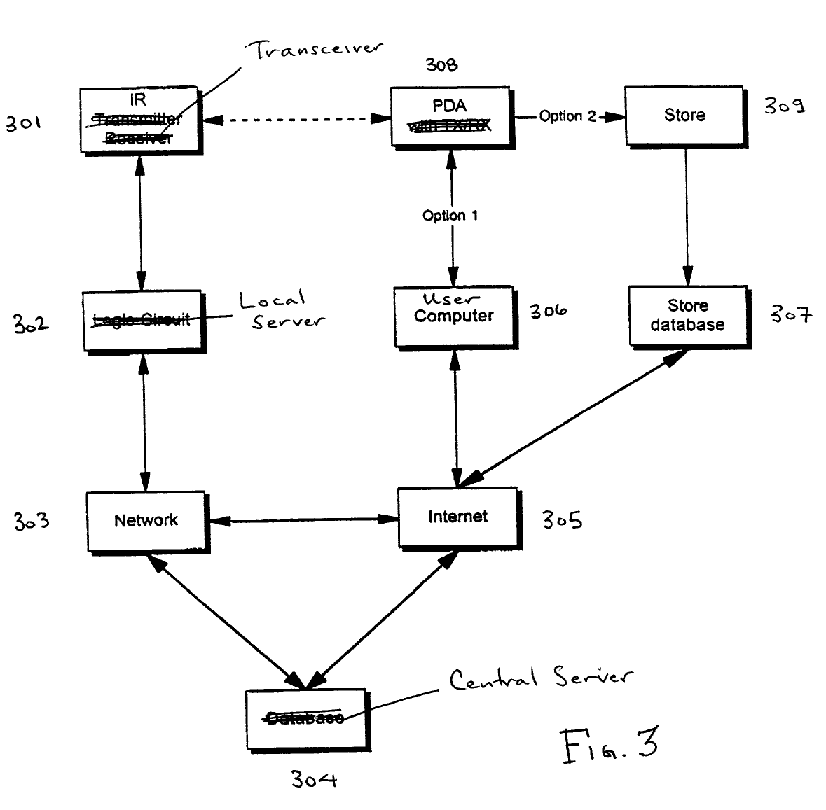

FIG. 3 depicts the components of the system as a whole, and indicates the various interconnections between them, covering both of the embodiments of the invention described above. In these embodiments, as above, the transceiver uses infrared transmission, and the user has a PDA equipped to receive infrared transmissions, such as for example, a Palm device. Beginning with an IR transceiver 301, there is a wireless data pathway to the PDA 308. The local server 302 supplies data to the transceiver, which it receives via the network 303, from the central server 304. The central server 304 can store its data in a database program, or the equivalent. The central server 304 is connected to the Internet, as is the network 303. Tracing the data flow on the user's side of the transmission, in the first embodiment of the invention the PDA 308 is connected to the user computer 306, during the synchronization process. The user computer 306 is then connected to the Internet 305 via the system resident application and the conduit, as described above, and the user redeems the coupon, or utilizes the downloaded information, at the coupon issuer's web site.

Because the user computer 306, the central server 304, and the network 303, are all three connected to the Internet 305, real time information regarding user downloads from the transceiver, or a plurality of transceivers 301, and coupon redemptions, or other user utilizations of the system, is available to the central server, the network, and the coupon issuer thereby providing connectivity to the whole system.

In the second embodiment of the invention, as described above, the user redeems the coupon or premium at an actual store 309, or the like, and the coupon or premium is stored in the handheld computing device, or PDA, 308, which is brought to the store with the user. The store that advertises on the kiosk is in the vicinity of the kiosk, therefore a user who downloaded coupon from the local server need not go far to obtain the benefit (e.g., coupon, advertisement, etc.) delivered to their PDA.

The hardware and/or software in the store 309 accesses the store database 307, allowing verification of the coupon, recording the redemption, and various other functions, and can also access the system database 304 as well as the network 303 via the Internet.

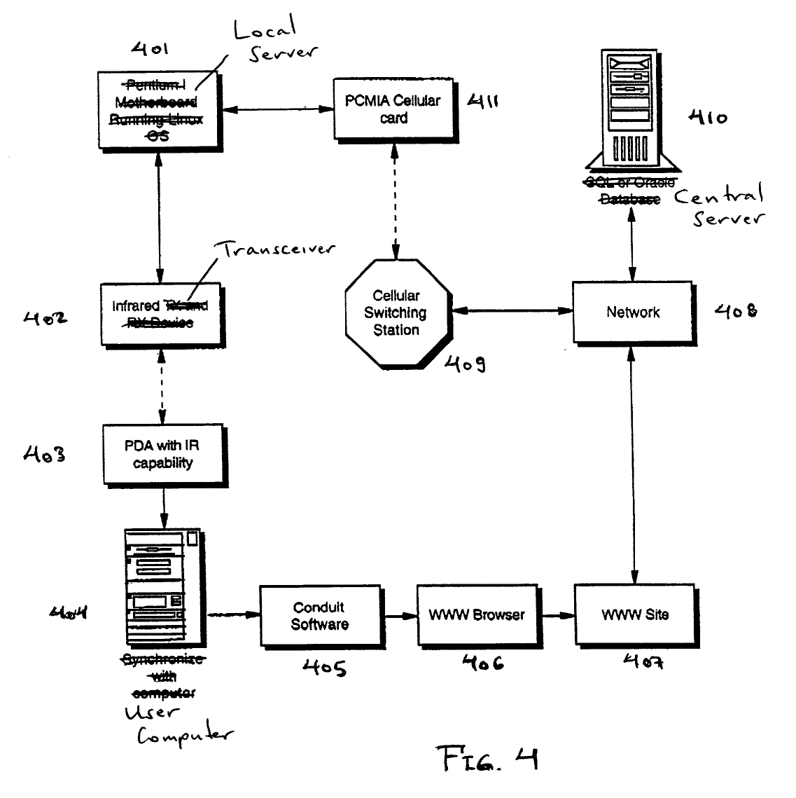

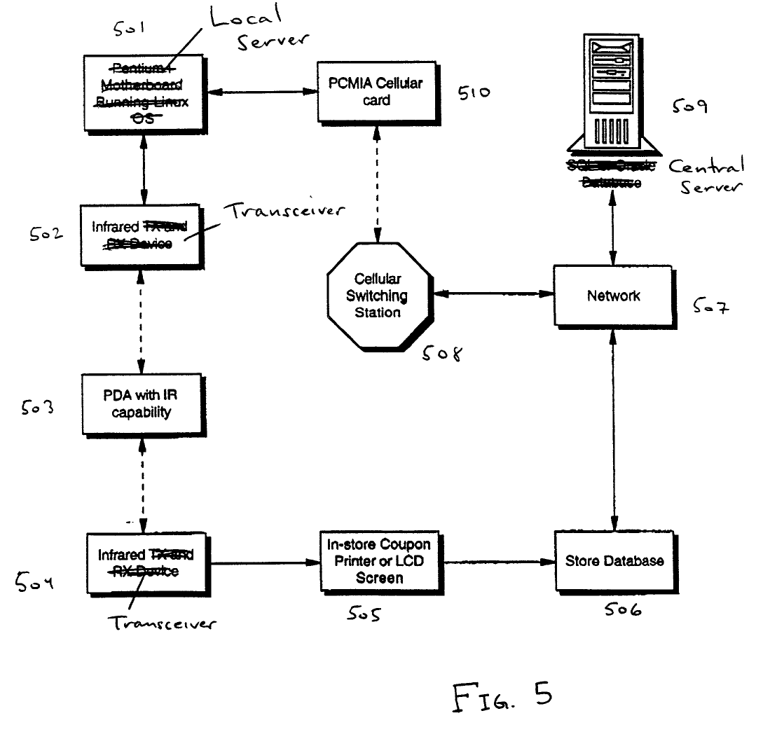

The next two figures illustrate at a greater level of detail the system of each of the two embodiments of the invention discussed above. FIG. 4 depicts the components of the system as used for an example of the online transaction embodiment, and FIG. 5 depicts the components of the system as used for an example of the physical retail store coupon redemption embodiment.

Referring to FIG. 4, the local server 401, is connected to, and controls, the infrared transceiver 402. The transceiver has an infrared link, shown as a dashed line, to the user's hand-held computing device, or PDA, 403. The PDA has infrared capability so as to be able to receive the transceiver's signal. The local server 401 is also connected to a resident PCMCIA cellular card 411, which connects to a communications network 408 via a cellular switching station 409. Thus the communications channel between the PCMCIA cellular card 411, and the cellular switching station 409 is a wireless one, and is thus shown by a dashed line. If a different type of communications network is used, or a different type of local server, these components 411 and 409 will be different, as appropriate to the particular type of communications network, and the required interface between the network and the local server.

Thus the data pathway through components 411, 409 and 408 can be accomplished via any wireless or other type of network connection where the network 408 can access the Internet and thus the coupon issuer's web site 407. The hand-held computing device 403 is ultimately synchronized with the user's computer 404, and the conduit software 405 is launched. The user then sees the prompt depicted in FIG. 9, and can be taken directly to the coupon issuer's web page via the user's installed web browser 406, or, alternatively, to the system home page as depicted in FIG. 12, via the user's web browser 406. At the coupon issuer's web site 407 the user redeems the downloaded coupon. The coupon issuer's web site is in communication with a communications network 408, such as, for example, the BellSouth network, as described above. The network 408 is in communication with the central server 410, which stores data in a database program such as, for example, SQL or Oracle. Thus the central server 410, the coupon issuer's web site 407, the Cellular Switching Station 409, and thus the local server 401, are all mutually connected via the communications network 408. As a result, data regarding the user who downloaded the coupon, on a handheld computing device, such as the PDA 403, as well as data regarding the redemption of the coupon at the issuer's web site 407 by the user, is continually available to the central server 410. Further, up to the minute data concerning the coupons to be offered and other issuer information is continually available to the central server 410 via the network 408, which is, in turn, transmitted to the various local servers 401, for accurate transmission to the user PDA 403.

FIG. 5 depicts a similar structure as shown in FIG. 4, with some modification. The local server 501 is connected to, and controls, the infrared transceiver 502. The device has an infrared link, shown as a dashed line, to the user's hand-held computing device, or PDA 503. The local server 501, as in FIG. 4, is connected to a resident PCMCIA cellular card 510, which connects to a communications network 507 via a cellular switching station 508.

Alternatively, the data pathway from components 510 through 508 to 507 can be accomplished via any wireless or other type of network connection where the network 507 can access the Internet and thus the Store database 506 of the coupon issuer. The hand-held computing device 503 electronically stores the transmitted coupon, and the user physically travels to the coupon issuer's store. In the coupon issuer's store, the user transmits the stored coupon to the store's infrared transceiver 504, which then prints the coupon, or, alternatively, displays the coupon on an LCD screen 505. This would occur at the point of sale in the store, or at some other in store coupon redemption location, such as a customer service counter or the like. The coupon's redemption is stored in the Store Database 506, which itself is connected to the communications network 507. As a result, data regarding the user who downloaded the coupon, on the PDA 503, as well as data regarding the redemption of the coupon at the coupon issuer's store, via a printer or LCD screen display 505 is available to the central server 509.

Further, up to the minute data concerning the coupons to be offered and other issuer information is continually available to the central server 509 via the network 507, which is, in turn, transmitted to the various local servers 501, for accurate transmission to the user hand held devices 503 via the infrared transceivers 502 connected to and controlled by the local servers 501. In addition, common attributes associated with kiosks can be added and updated such as location, address, and others. Similarly, common attributes of advertisers and advertisement can be added and updated such as contact information, store locations, and other details. In addition, a user can assign an advertisement to one or more kiosks for a specified date range.

In a third embodiment of the present invention the user downloads an application from the device that is either a game or some type of schedule viewer, such as for movies or transit, etc. The user is the ultimate consumer of the downloaded application on their device and there is no further action required from them. The data pathway is similar to those depicted in FIG. 3, except the data path ends at the equivalent of the user hand-held computing device 308, or for some applications, the user computer 306. Alternatively a “game coupon” or “software coupon” could be downloaded, and redeemed by downloading the full game or program at either an issuer's web site or physical location, in which case the data paths are identical to those depicted in FIGS. 3, 4 and 5.

In a fourth, fifth and sixth embodiment of the invention, parallel to the first second and third embodiments of the invention as described above, the communications medium between the remote hand-held computing device and the transceiver is any wireless electromagnetic signal, not restricted to any particular frequency, and not requiring a line of sight between the transceiver and the hand-held computing device for data communication. Preferably, these devices are enabled with the Wireless Application Protocol (WAP). The Wireless Application Protocol (WAP) is a secure specification that allows users to access information instantly via handheld wireless devices such as mobile phones, pagers, two-way radios, smartphones and communicators.

WAP supports most wireless networks. These include CDPD, CDMA, GSM, PDC, PHS, TDMA, FLEX, ReFLEX, iDEN, TETRA, DECT, DataTAC, and Mobitexa. WAP is supported by all operating systems. Ones specifically engineered for handheld devices include PalmOS, EPOC, Windows CE, FLEXOS, OS/9, and JavaOS. WAP devices that use displays and access the Internet run what are called microbrowsers—browsers with small file sizes that can accommodate the low memory constraints of handheld devices and the the low-bandwidth constraints of a wireless-handheld network.

Although WAP supports HyperText Markup Language (HTML) and extensible Markup Language (XML), the Wireless Markup Language (WML; an XML application) is specifically devised for small screens and one-hand navigation without a keyboard. WML is scalable from two-line text displays up through graphic screens found on items such as smart phones and communicators. WAP also supports WMLScript. It is similar to JavaScript, but makes minimal demands on memory and CPU power because it does not contain many of the unnecessary functions found in other scripting languages.

Because WAP is fairly new, it is not a formal standard as of the filing date of this application. It is still an initiative that was started by Unwired Planet, Motorola, Nokia, and Ericsson.

In the fourth, fifth and sixth embodiments the maximum distance between the WAP enabled hand held computing device and the transceiver is potentially much greater than such maximum distance between the transceiver and user hand-held device of the first, second and third embodiments that are infrared enabled, and thus larger signage, and signage placed farther away from the street or public place, such as the large sized billboards overlooking large urban plazas, can be fitted with the system.

Instead of infrared beaming of information to a WAP device, a WAP-User will navigate to a system URL through a WAP browser and enter an identification number (ID) displayed on the kiosk. The unique kiosk ID will identify which kiosk the user is located at and will transmit appropriate content for that particular kiosk to the WAP device. If there is an offer associated with the advertisement the user will be able to redeem it at local merchant stores with the data they received. The back-end server, described in more detail below, is designed to handle current WAP transactions and also allows for future automation of advertisement scheduling and content management with real-time update capability.

As stated above, the store that advertises preferably is located within the vicinity of the advertisement, thereby providing the user who downloaded a coupon easy access to the store providing the advertisement special. Similarly, in this embodiment of the present invention, even though the information is gathered from a source that is relatively far from the WAP enabled device (i.e., a distance farther than an infrared device can transmit), it is preferable that the store which provided the advertisement be located in the vicinity of the billboard from which the user retrieved. Included with the information, can be directions to the store in the form of a map or text directions.

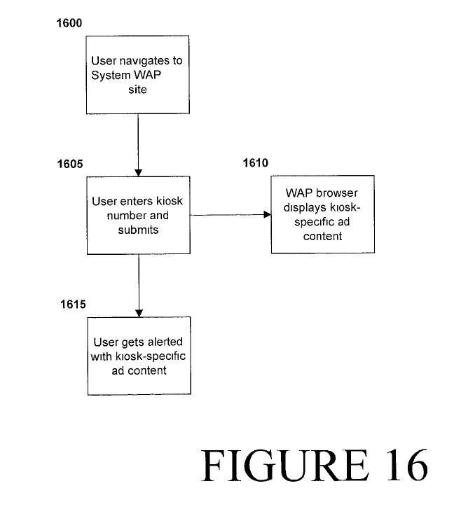

FIG. 16 is flow diagram showing the steps for processing a WAP procedure in accordance with an embodiment of the present invention. In step 1600, a user navigates a WAP enabled device to the URL corresponding to a system home page. Next, in step 1605, the system site will prompt the user to enter a kiosk number. The user can then input the numeric kiosk number using the keypad and submit the kiosk number by pressing OK. In one preferred embodiment, WML is used to present content to WAP enabled devices. Screens can be rendered in WML from the extensible Markup Language (XML), allowing the content to be device independent (i.e., the same content will be usable across multiple platforms, not just WAP). The WAP input form can be generated by using an Active Server Page (ASP).

The basic premise underlying XML is the ability to separate the actual data from the way it is presented. In doing so, the logic of an application is able to create common sets of XML data and remain indifferent as to where the content will be delivered. An accompanying technology, extensible Stylesheet Language (XSL), is actually tasked with transforming, or rendering, the generic XML structure into content understandable to a specific device. XSL acts as the translator of XML structures, generating multiple markup languages, so that several different wireless technologies can receive the same content in a manner they understand.

In using this XML based methodology, the storage of content, as well as the way business logic is applied at the server level, remains independent of the device making a request. A long term benefit of such a methodology is that database structures, as well as application logic, require minimal changes as different devices are supported. Real modifications occur mainly within the logic of the XSL sheets used to transform the raw XML data.

The technical architecture underlying the present invention application expands upon the aforementioned XML methodology. Through the use of Active Server Pages (ASPS) and Component Object Modeling (COM), the application can dynamically generate XML structures as a particular device requests content. This aspect of the invention is discussed in more detail below.

In step 1610, the WAP browser displays kiosk-specific advertisement content. The next set of screens displayed to the user will contain the advertising content corresponding to the kiosk number entered. If multiple screens of content exist, WML cards can be used to optimize the speed of screen delivery. A WML card is [Please provide us with additional technical details].

Referring back to FIG. 16, in step 1615 the user receives an alert with kiosk-specific advertisement content previously displayed on the screen in step 1610. The alert will reside in the user's inbox providing easy access to the advertising content (even if the device is not connected to the Internet). It is also possible to have automated alerts by extracting the device's Subscriber ID number from the WAP gateway. If a particular mobile communications carrier chooses to disable the use of a device's Subscriber ID, the viewing of advertising content will still exist via the WAP browser screen.

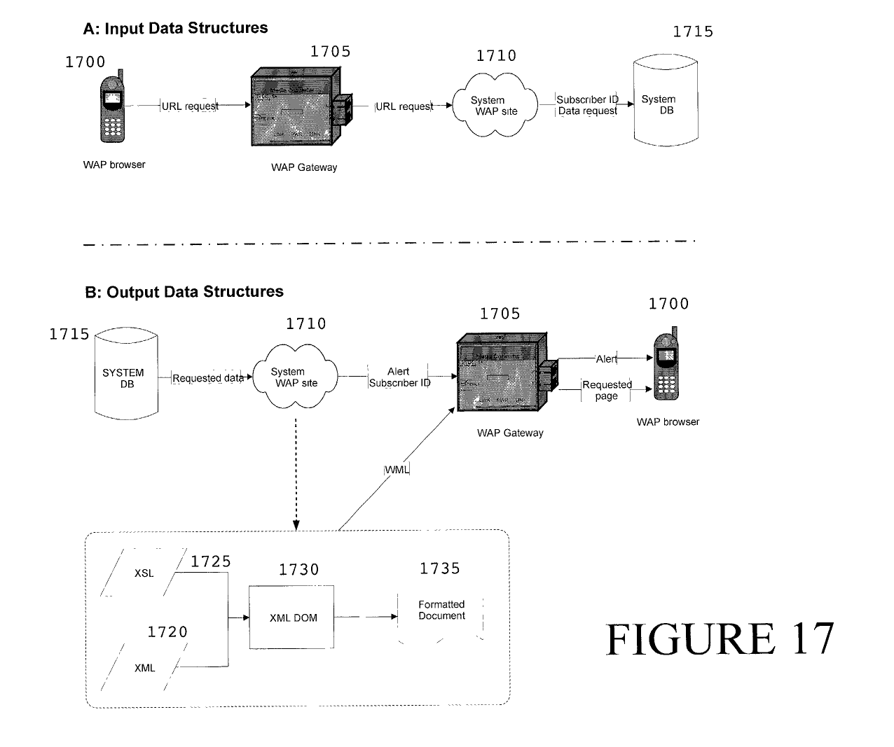

FIG. 17 is a block diagram of the input and output data structures in accordance with processing WAP information. A WAP device 1700 makes a request to a URL located at the system home page WAP site 1710 for a piece of dynamic information stored in a database 1715. The WAP request will be received by a WAP gateway 1705 hosted by the carrier network. The WAP gateway 1705 will convert the WAP request into an HTTP generated ASP request understandable by the webserver on the system website 1710. The webserver then will receive the request and check for environment variables associated with it.

The user agent environment variable describes the type of device making the request, in this case a WAP device. The webserver will then look for a subscriber ID associated with the requester, to be inserted into the database 1715 and used to send an alert later. The subscriber ID, unique to the device making the request, can also be stored along with the kiosk number, date, and time of the request it made. This data can be used for future userbase analysis.

The application can use an XML and XSL rendering process to generate WML for the user's WAP browser 1700. The WML page will prompt the user to enter a kiosk number. Once the kiosk number is submitted, a stored procedure extracting content specific to that kiosk will be executed. The stored procedure will return a recordset containing the content, which can then be dynamically structured into XML 1720 and passed to an instance of an XML DOM 1730 (extensible Markup Language Document Object Model), which parses the XML formatted file into a data structure, such as a tree structure or the like. The appropriate XSL stylesheet 1725 can then be selected and passed to the XML DOM 1730, where a formatted WML document 1735 is generated from the advertisement content.

The resulting WML content (i.e., formatted document) 1735 would then be returned to the WAP requester via the WAP gateway 1705 and displayed on the user's device. If a subscriber ID exists as an environment variable, the same WML content would be passed out through a messaging object. The messaging object would then send the content to the device's message inbox.

This embodiment can also include airport, subway, bus, ferry, and commuter railroad schedules for transportation pickup locations located near this invention can be downloaded and displayed on the PDA. Thus, a user will know if they have time to shop at a nearby retailer while waiting for their transportation.

In addition, since the WAP enabled device (or wireless PDA) can be continuously updated with new information, as described above, transportation schedules can be continuously updated. This provides users of this invention with a convenient way of viewing accurate transportation schedule information. This embodiment and the wireless PDA embodiments also can provide automatic alerts of delayed or on schedule transportation.

Another aspect of the present invention is the kiosk maintenance process. This process involves sending advertisements to a kiosk local server and in turn collecting transaction data from each kiosk local server to update the database. A maintenance PDA device is configured with a maintenance Infrared Data Association identification (IrDA ID) string that the kiosk local server will recognize and stop its continuous beaming. The advertisement contained on the maintenance PDA will overwrite the current advertisement information contained on the kiosk local server, and will collect all information contained in the kiosk transaction log since the last maintenance transmission. The data stored on the maintenance PDA will then be uploaded to a database when the maintenance user synchronizes the maintenance PDA with a personal computer (PC).

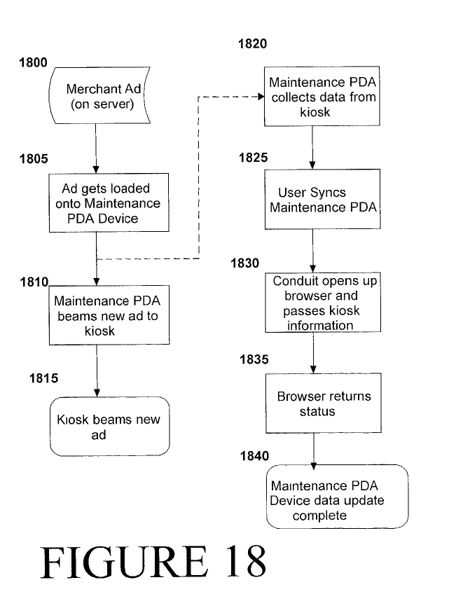

FIG. 18 is a process diagram showing the steps for maintaining advertisements on a kiosk local server. First, in step 1800, an advertisement is placed on a central server. In step 1805, the previously stored advertisement gets loaded onto a maintenance PDA device. Note that an advertisement can include an application (or other information) to be installed on the PDA devices or PC. In addition, the device can be configured with a unique IrDA ID string.

In step 1810, the maintenance PDA beams an advertisement to the kiosk local server via the kiosk transceiver. When the maintenance device is recognized by the kiosk local server, the program already loaded on the kiosk local server goes into an ‘accept’ state, ready to accept the advertisement previously loaded onto the maintenance PDA device from the back-end server. If there was already an advertisement on the kiosk local server, then a new advertisement replaces the advertisement on the kiosk local server. Otherwise the new advertisement is simply placed on the kiosk local server.

After the advertisement has been uploaded to the kiosk local server, the kiosk local server can beam the new advertisement via the kiosk transceiver, as shown in step 1810. The kiosk local server can be programmed so that once the kiosk local server loses its connection with the maintenance device, it restarts and begins to continuously monitor for devices to beam to, as shown in step 1815.

The maintenance PDA, in step 1820, can also collect data from a kiosk local server. After the data has been collected, the user can upload the data to the central server, as shown in step 1825. In step 1825, the maintenance PDA device is placed in a desktop cradle and synchronized. As shown in step 1830, during the synchronization process a conduit opens up a browser and passes kiosk local server information by HTTP posting to a system URL. An ASP handles database connection and actual input. Next, in step 1835, the browser returns the status of the transmission such as whether insertion was successful. If appropriate a detailed error message also can be displayed. Step 1840 merely shows that the maintenance PDA device data update is complete.

Another aspect of the present invention is a process for synchronizing via a conduit. The conduit will send data to a system central server and provide a way to link directly to the advertisements' corresponding websites. The process starts when the user performs a synchronization and the conduit is triggered. The user's PDA is checked for newly beamed advertisements and that information is passed along to the system central server. A dialog box is displayed and the user can navigate to the merchant sites associated with the new advertisements at that time. If the user chooses to navigate to a merchant's site the conduit will open the default browser and display a list of merchant links connected to the merchant sites. The user has the option of selecting a link that will open the merchant's website. The_system central server can track the number of users that are redirected to a particular advertiser. This process also allows for participation in various types of affiliate programs with advertisers, empowering the user to conveniently access merchant sites while also recording user data.

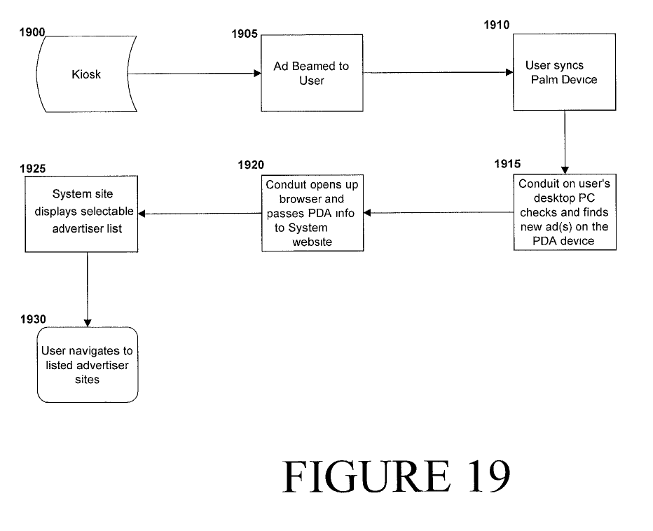

FIG. 19 is a process diagram showing the steps for a PDA Conduit synchronization. As shown in step 1900, the kiosk local server will contain the advertisement to be beamed out to the PDA user. As described above, in step 1905 the user receives the beamed advertisement on his PDA device. After the user has received the advertisement on his PDA device the user can synchronize the PDA device to a PC.

In step 1910, the user connects the PDA device to a PC computer (using an infrared or wired connection, or the like), and initiates a synchronization. Upon synchronization the conduit on the user's PC, in step 1915, checks for new advertisement(s) on the PDA Device. If advertisements are found, in step 1920, the conduit launches a browser and passes PDA information to the system website. In addition, a list of advertiser hyperlinks is displayed on the browser, as shown in step 1925, allowing the user to navigate to one of them, as shown in 1930. If the user chooses to navigate to an advertiser from the list, the conduit on the user's desktop PC will launch the default browser and the conduit will make an HTTP Post to the system URL (ASP) with the following parameters collected from the PDA device: Advertisement IDs from PDA device, DateTime Stamp of Advertisements, and User ID (exists from registration) and other Profiles.

Based on the parameters passed by the conduit, ASP logic will call a stored procedure in the database to record the user ID, advertisements beamed, and date/time of each advertisement received. The stored parameters can be kept for analysis/reporting. In addition, along with a display of advertiser links (associated with each beamed advertisement), the browser can be configured to display other relevant content related to each advertiser.

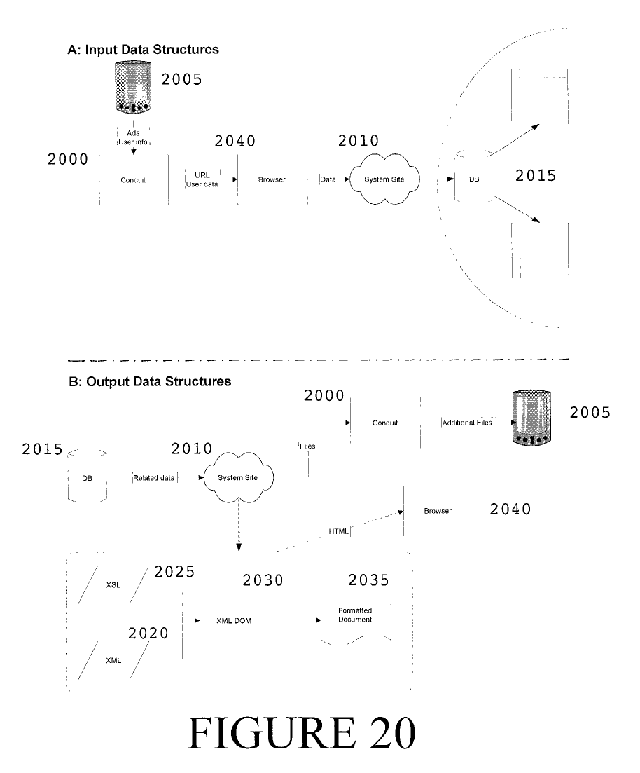

FIG. 20 is a block diagram of the PDA device synchronization process. The conduit 2000 (already installed) will be triggered upon a user synchronization. The conduit checks for a unique identifier assigned to the user's device and, if no identifier is found, the conduit requests the system site to assign the device 2005 one. The conduit 2000 will then check for new advertisements on the user's device 2005 and, if found, will extract the unique identifier and advertisement Ids from the device 2005.

Upon user confirmation, the conduit 2000 will launch the operating system's default browser 2040 and set the window location to a predefined system URL (pointing to an ASP page). The conduit 2000 will also make an HTTP Post of the unique identifier and advertisement IDs previously extracted from the device 2005. The ASP page would receive these parameters and pass them to a stored procedure in a database 2015. The stored procedure performs table inserts, keeping the relationship between the device's unique identifier and the advertisements.

The stored procedure will then query for URLs and additional content relating to the advertisements. A recordset containing the unformatted content will be passed back to the ASP page. The ASP page would then create an XML structure 2020 representing the returned recordset values. The XML structure 2020 is then passed on to an instance of the XML DOM parser 2030. Since the request was made from a desktop browser, an XSL stylesheet 2025 specific to HTML also will be loaded into the XML DOM parser 2030. The transform method of the XML DOM will be called, and the resulting output (HTML formatted document 2035) will be returned to the desktop browser. The resulting HTML output will display extra content and hyperlinks, if applicable, corresponding to each advertisement. If other files associated with an advertisement exist, the conduit will receive the location path of the file(s). The conduit will then retrieve the appropriate files.

Another aspect of the present invention is the conduit download and installation process. This process allows a user to beam an advertisement from a kiosk local server and ultimately download the conduit that directs a user to vendor sites upon synchronization between the user's PC and PDA device. Instructions to visit the system website are embedded in all beamed advertisements. As described above, the user must actively access the system website and complete the registration form before he can download and install the conduit on a PDA device. This registration information is used to identify individual users and record information about them. These records can be kept on a database for future marketing analysis.

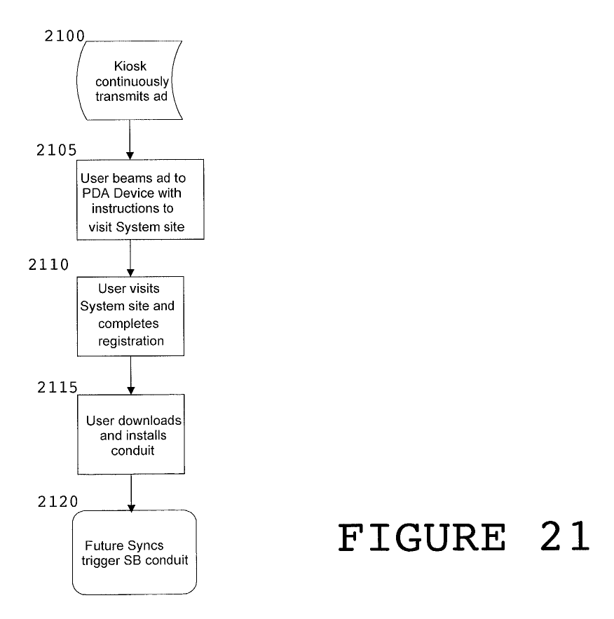

FIG. 21 is a process diagram showing the steps for the conduit download and installation described above. As shown in step 2100, a kiosk local server continually transmits an advertisement. Next, in step 2105, a user beams an advertisement to a PDA device with instructions to visit the system website. Instructions to visit the system website can be embedded within all advertisements. The user, in step 2110, visits the system website and completes the registration form. In addition, user information is collected and stored upon registration completion. This embodiment can be made such that registration must be completed before a user can download a conduit. In step 2115, the user downloads and installs the conduit and, as shown in step 2120, synchronizations following future advertisement transmissions will trigger the conduit.

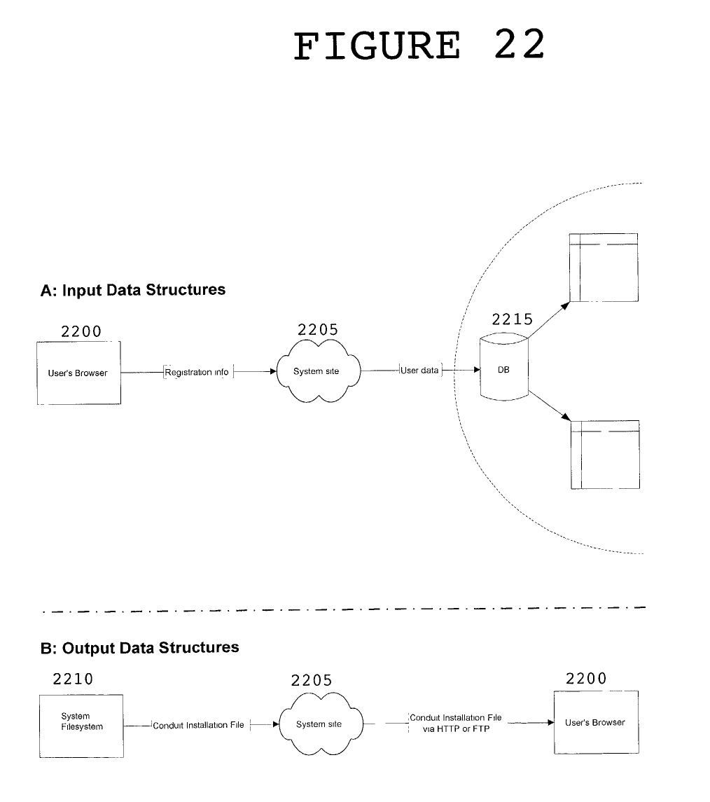

FIG. 22 is a block diagram of the conduit download process. The registration form is an HTML generated ASP page containing minimal items of information to complete. The user fills out the form on a browser 2200 and upon submission the user information will be sent via HTTP Post to the ASP page on the system website server 2205. The user information will then be passed as parameters to a database 2215 stored procedure. The database 2215 stored procedure will insert the parameters into various user tables. The stored procedure located on the system's filesystem 2210 will output a return value indicating the status of the table insertion (success or fail) to the ASP page located on the system website 2205. If the insertion failed for some reason, the user will be prompted on his browswer 2200 to resubmit the information. If successful, the ASP page will automatically download the installation file. If the browser 2200 does not start downloading the installation file, a link pointing to the installation file will be provided for the user to click on.

As described above, the system of the invention time stamps and records in a history file or files, and stores in a system database, or equivalent program or data structure, running on the central server, each data transfer between any remote transceiver and a hand held personal computing device, who the user was who received the information or data, which transceiver sent the information, and whether the user ultimately redeemed the received coupon or premium, or otherwise used the information or data. As a result, the system develops data which is highly useful and desirable in the marketplace. In yet another embodiment of the invention, the system of the invention is utilized to produce market research data such as (i) the number of “hits” to a particular sign or collection of signs equipped with the system apparatus in a given time interval, (ii) the response rate to a particular promotion featured on one or many system enhanced sings, (iii) demographic data as to who is accessing and ultimately redeeming or using the information delivered by the system, and what socioeconomic, or other market defined categories, the users fall into, as well as defining what other market activities and preferences they may engage in or have. This information is then made available by the system to advertising and marketing tracking services to accurately track individual signs, or collections thereof, as a marketing tool to the public. The system, in this manner, can acquire numerous strategic partnerships, business advantages, and revenue centers as a compiler and provider of market data as described above, and thus enhance the overall prominence and popularity of the system, recognition of the system logo, and increase the percentage of available signage that carries the system, as a result.

The database portion of the present invention is designed with a strong emphasis on scalability. In order to provide the consumer with the best user experience possible, the system can cater to specific devices, as each device is optimized for a different underlying technology. The database design supports profiles of devices that are currently used and allows additional devices to be easily added to the system. Thus, future devices can be added without the nuisance of actually changing the database structure.

The fundamental design allowing this level of scalability is a key value pairing schema. Rather than developing separate table collections for each device platform, a single table collection is used to consolidate multiple device attributes. The design permits device characteristics to be stored in rows rather than fixed columns, allowing for truly scalable device profiling. XML structures are then able to include device attributes as elements, providing the application logic instructions for its intended target.

The same device profiling method would be used to deliver to devices outside of the United States. In Europe, where WAP devices differ greatly in their ability to display content, detailed profiles can be used for optimized content display on different devices.

Another aspect of the present invention is isolating the user from the actual device being used. This inserts another layer of platform independence and allows for a more efficient means of content delivery. The degree of content customization allowed is then flexible enough to customize for a particular device platform, a particular user group, or a particular user.

Potential capabilities, such as co-branding, user notifications, and userbase analysis, can easily be implemented due to the open nature of the database design. Ad hoc reporting is optimized so that countless analyses can be derived and constructed.

Preferably, the present invention removes most of the data extraction processes from the application layer and places them into SQL Server stored procedures, rather than traditional inline queries.

The stored procedures are parameterized and can act as functions that extract data directly from tables. This allows for a much higher degree of component reusability on the database than what is traditionally designed for. Should the application platform change, database extraction processes would not need to be modified because they are already isolated to the back-end. In other words, the procedures are indifferent of the application platform trying to access them because they are designed simply to accept the required parameters and output the unformatted content. Maintaining queries is also more manageable because database queries are not combined within the actual business logic of the application as in conventional inline queries.

While the present invention has been described in detail with reference to the preferred embodiments thereof, many modifications and variations of these described embodiments will be readily apparent to those skilled in the art. Accordingly, the scope of the invention is not to be limited by the details of the preferred embodiments described above, but only by the terms of the appended claims.

What is claimed:

1. A method for communicating data between a local server and a central server connected to a network, comprising:
storing data onto the central server;
storing an identification string onto the central server;
loading the identification string onto a personal digital assistant device;
loading the data onto the personal digital assistant device;
transmitting the data from the personal digital assistant device to the local server;
transmitting other data from the local server onto the personal digital assistant device; and
transferring the other data from the personal digital assistant device to the central server.

2. A method according to claim 1, wherein the step of transferring the other data further comprises:
synchronizing the personal digital assistant device to a personal computer connected to the network;
posting the other data to a web application server on the network;
transferring the other data to the central server; and
receiving a status message from the web application server.

3. A method according to claim 1, further comprising:
inhibiting the local server from transmitting; and
enabling the local server to transmit after the communications between the local server and the personal digital assistant is complete.

4. A method according to claim 1, wherein the personal digital assistant device is a Palm device.

5. A method according to claim 1, wherein the data includes information from a retailer located within the vicinity of the local server.

6. A method according to claim 1, wherein the data includes a transportation schedule for transportation pickup locations located within the vicinity of the local server.

7. A method according to claim 1, wherein the data includes a game.

8. A method for connecting a browser to a web application server, comprising:
transmitting data to the personal digital assistant device;
receiving and storing the data in the personal digital assistant device;
synchronizing the personal digital assistant device with a personal computer;
registering a user by providing user identification information to the web application server;
launching a browser on the personal computer;
posting information from the personal computer to the web application server, wherein the information comprises:
the data transmitted to the personal digital assistant;
a timestamp, and
a user identifier;
storing the posted information onto a central server; and
displaying on the browser information corresponding to the data.

9. A method according to claim 8, wherein the information displayed on the browser includes at least one hyperlink.

10. A method according to claim 9, further comprising:
recording referral information associated with the data on the central database.

11. A method according to claim 8, further comprising:
analyzing the information posted by said posting step; and
determining marketing information.

12. A method according to claim 8, wherein the data includes information from a retailer located within the vicinity from where the transmitting step occurred.

13. A method according to claim 8, wherein the data includes a transportation schedule for transportation pickup locations located within the vicinity from where the transmitting step occurred.

14. A method according to claim 8, wherein the data includes a game.

15. A method for accessing Internet websites using a personal digital assistant and a personal computer connected to an Internet, comprising:
transmitting data from a local server to the personal digital assistant, wherein the data includes
instructions on how to access a web application server, the instructions being viewable on the personal digital assistant, and
location specific data;
accessing the web application server;
registering a user's information on the web application server;
receiving a user identifier on the personal digital assistant after successfully completing said registering step;
downloading and installing a conduit onto a personal computer after completing said registering step if the conduit is not already installed on the personal computer;
triggering the conduit during a synchronization of the personal digital assistant to the personal computer;
checking for the user identifier on the personal digital assistant device;
sending the user identifier to the web application server from the personal digital assistant device if the user identifier is found;
requesting the user's information from a central server via the Internet if the user identifier was not found in the checking step;
locating other data on the central server associated with the location specific data;
querying the central server for at least one hyperlink associated with the other data; and
displaying the at least one hyperlink on a browser on the personal computer.

16. A method according to claim 15, wherein the other data includes information from a retailer located within a predetermined distance of the local server.

17. A method according to claim 15, wherein the other data includes a transportation schedule for at least one transportation pickup location located within the vicinity of the local server.

18. A method according to claim 15, wherein the other data includes a game.

19. A method for delivering data to a computing device with a browser, comprising:
viewing an identification number on a display;
inputting the identification number into the computing device;
connecting the computing device to a web application server via the Internet;
transmitting from the computing device to the web application server the identification number; and
receiving at the computing device from the web application server data associated with the display.

20. A method according to claim 19, wherein the computing device is a wireless application protocol enabled device.

21. A method according to claim 19, wherein the computing device is a personal computer connected to the Internet.

22. A method according to claim 19, wherein the computing device is a hand-held computing device.

23. A method for delivering data to a wireless application protocol enabled device, comprising:
viewing an identification number on a display;
inputting the identification number into the wireless application protocol enabled device;
connecting the wireless application protocol enabled device to a web application server via the Internet;
transmitting from the wireless application protocol enabled device to the web application server the identification number;
receiving at the wireless application protocol enabled device from the web application server data associated with the display;
extracting a subscriber identification of the wireless application protocol enabled device from a wireless application protocol gateway;
mapping the data to a modified data; and
alerting the user of the modified data.

24. A method according to claim 19, wherein the data includes information about a retailer located within the vicinity of the display.

25. A method according to claim 19, wherein the data includes a transportation schedule for at least one transportation pickup location located within the vicinity of the display.

26. A method according to claim 19, wherein the data includes a game.

27. An apparatus for communicating data between a local server and a central server connected to a network, comprising:
means for storing data onto the central server;
means for storing an identification string onto the central server;
means for loading the identification string onto a personal digital assistant device;
means for loading the data onto the personal digital assistant device;
means for transmitting the data from the personal digital assistant device to the local server;
means for transmitting other data from the local server onto the personal digital assistant device; and
means for transferring the other data from the personal digital assistant device to the central server.

28. An apparatus according to claim 27, wherein the means for transferring the other data further comprises:
means for synchronizing the personal digital assistant device to a personal computer connected to the network;
means for posting the other data to a web application server on the network;
means for transferring the other data to the central server; and
means for receiving a status message from the web application server.

29. An apparatus according to claim 27, further comprising:
means for inhibiting the local server from transmitting; and
means for enabling the local server to transmit after the communications between the local server and the personal digital assistant is complete.

30. An apparatus according to claim 27, wherein the personal digital assistant device is a Palm device.

31. An apparatus according to claim 27, wherein the data includes information from a retailer located within the vicinity of the local server.

32. An apparatus according to claim 27, wherein the data includes a transportation schedule for transportation pickup locations located within the vicinity of the local server.

33. An apparatus according to claim 27, wherein the data includes a game.

34. An apparatus for connecting a browser to a web application server, comprising:
means for transmitting data to a personal digital assistant device;
means for receiving and storing the data in the personal digital assistant device;
means for synchronizing the personal digital assistant device with a personal computer;
means for registering a user by providing user identification information to the web application server;
means for launching a browser on the personal computer;
means for posting information from the personal computer to the web application server, wherein the information comprises:
the data transmitted to the personal digital assistant;
a timestamp, and
a user identifier;
means for storing the posted information onto a central server; and
means for displaying on the browser information corresponding to the data.

35. An apparatus according to claim 34, wherein the information displayed on the browser includes at least one hyperlink.

36. An apparatus according to claim 35, further comprising:
means for recording referral information associated with the data on the central database.

37. An apparatus according to claim 34, further comprising:
means for analyzing the posted information; and
means for determining marketing information.

38. An apparatus according to claim 34, wherein the data includes information from a retailer located within the vicinity of said means for transmitting.

39. An apparatus according to claim 34, wherein the data includes a transportation schedule for transportation pickup locations located within the vicinity of said means for transmitting.

40. An apparatus according to claim 34, wherein the data includes a game.

41. An apparatus for accessing Internet websites using a personal digital assistant and a personal computer connected to an Internet, comprising:
means for transmitting data from a local server to the personal digital assistant, wherein the data includes
instructions on how to access a web application server, the instructions being viewable on the personal digital assistant, and
location specific data;
means for accessing the web application server;
means for registering a user's information on the web application server;
means for receiving a user identifier on the personal digital assistant after the means for registering has successfully completed registering the user's information;
means for downloading and installing a conduit onto a personal computer if the conduit is not already installed on the personal computer;
means for triggering the conduit during a synchronization of the personal digital assistant to the personal computer;
means for checking for the user identifier on the personal digital assistant device;
means for sending the user identifier to the web application server from the personal digital assistant device if the user identifier is found;
means for requesting the user's information from a central server via the Internet if the user identifier was not found using the means for checking;
means for locating other data on the central server associated with the location specific data;
means for querying the central server for at least one hyperlink associated with the other data; and
means for displaying the at least one hyperlink on a browser on the personal computer.

42. An apparatus according to claim 41, wherein the other data includes information from a retailer located within a predetermined distance of the local server.

43. An apparatus according to claim 41, wherein the other data includes a transportation schedule for at least one transportation pickup location located within the vicinity of the local server.

44. An apparatus according to claim 41, wherein the other data includes a game.

45. An apparatus for delivering data to a computing device with a browser, comprising:
means for viewing an identification number on a display;
means for inputting the identification number into the computing device;
means for connecting the computing device to a web application server via the Internet;
means for transmitting from the computing device to the web application server the identification number; and
means for receiving at the computing device from the web application server data associated with the display.

46. An apparatus according to claim 45, wherein the computing device is a wireless application protocol enabled device.

47. An apparatus according to claim 45, wherein the computing device is a personal computer connected to the Internet.

48. An apparatus according to claim 45, wherein the computing device is a hand-held computing device.

49. An apparatus for delivering data to a wireless application protocol enabled device, comprising:
means for viewing an identification number on a display;
means for inputting the identification number into the wireless application protocol enabled device;
means for connecting the wireless application protocol enabled device to a web application server via the Internet;
means for transmitting from the wireless application protocol enabled device to the web application server the identification number;
means for receiving at the wireless application protocol enabled device from the web application server data associated with the display;
means for extracting a subscriber identification of the wireless application protocol enabled device from a wireless application protocol gateway;
means for mapping the data to a modified data; and
means for alerting the user of the modified data.

50. An apparatus according to claim 45, wherein the data includes information about a retailer located within the vicinity of the display.

51. An apparatus according to claim 45, wherein the data includes a transportation schedule for at least one transportation pickup location located within the vicinity of the display.

52. An apparatus according to claim 45, wherein the data includes a game.

53. A computer program, for communicating data between a local server and a central server connected to a network, operable to:
store data onto the central server;
store an identification string onto the central server;
load the identification string onto a personal digital assistant device;
load the data onto the personal digital assistant device;
transmit the data from the personal digital assistant device to the local server;
transmit other data from the local server onto the personal digital assistant device; and
transfer the other data from the personal digital assistant device to the central server.

54. A computer program, according to claim 53, wherein the transfer step is further operable to:
synchronize the personal digital assistant device to a personal computer connected to the network;
post the other data to a web application server on the network;
transfer the other data to the central server; and
receive a status message from the web application server.

55. A computer program, according to claim 53, further operable to:
inhibit the local server from transmitting; and
enable the local server to transmit after the communications between the local server and the personal digital assistant is complete.

56. A computer program for connecting a browser to a web application server, operable to:
transmit data to a personal digital assistant device;
receive and store the data in the personal digital assistant device;
synchronize the personal digital assistant device with a personal computer;
register a user by providing user identification information to the web application server;
launch a browser on the personal computer;
post information from the personal computer to the web application server, wherein the information comprises:
the data transmitted to the personal digital assistant;
a timestamp, and
a user identifier;
store the posted information onto a central server; and
display on the browser information corresponding to the data.

57. A computer program, for accessing Internet websites using a personal digital assistant and a personal computer connected to an Internet, operable to:
transmit data from a local server to the personal digital assistant, wherein the data includes
instructions on how to access a web application server, the instructions being viewable on the personal digital assistant, and
location specific data;
access the web application server;
register a user's information on the web application server;
receive a user identifier on the personal digital assistant after successfully completing said register step;
download and installing a conduit onto a personal computer after completing said register step if the conduit is not already installed on the personal computer;
trigger the conduit during a synchronization of the personal digital assistant to the personal computer;
check for the user identifier on the personal digital assistant device;
send the user identifier to the web application server from the personal digital assistant device if the user identifier is found;
request the user's information from a central server via the Internet if the user identifier was not found in the check step;
locate other data on the central server associated with the location specific data;
query the central server for at least one hyperlink associated with the other data; and
display the at least one hyperlink on a browser on the personal computer.

58. A computer program, for delivering data to a computing device with a browser, operable to:
view an identification number on a display;
input the identification number into the computing device;
connect the computing device to a web application server via the Internet;
transmit from the computing device to the web application server the identification number; and
receive at the computing device from the web application server data associated with the display.

59. A computer program, for delivering data to a wireless application protocol enabled device with a browser, operable to:
view an identification number on a display;
input the identification number into the wireless application protocol enabled device;
connect the wireless application protocol enabled device to a web application server via the Internet;
transmit from the wireless application protocol enabled device to the web application server the identification number;
receive at the wireless application protocol enabled device from the web application server data associated with the display;
extract a subscriber identification of the wireless application protocol enabled device from a wireless application protocol gateway;
map the data to a modified data; and
alert the user of the modified data.
